(19) United States
(12) Patent Application Publication
(10) Pub. No.: US 2012/0124489 A1
(43) Pub. Date: May 17, 2012

(54) Implement Method, Operation Method, and System for No Installing Data Card Driver

(75) Inventors: Ming Zhao, Guangdong Province (CN); Bing Chen, Guangdong Province (CN); Zhao Zuo, Guangdong Province (CN); Junhong Jin, Guangdong Province (CN)

(73) Assignee: ZTE CORPORATION, Shenzhen City, Guangdong Province (CN)

(21) Appl. No.: 13/258,090

(22) PCT Filed: Jul. 30, 2009
(86) PCT No.: PCT/CN2009/000854

§ 371 Date: Dec. 9, 2011

(30) Foreign Application Priority Data
Jun. 12, 2009 (CN) 200910203770.5

(51) Int. Cl. G06F 3/01

(52) U.S. Cl. 715/760

(57) ABSTRACT

An implementation method, an operation method and a system of a data card driver free installation are provided. The implementation method includes following steps. Device side software of a data card is taken as a compound device with a HID function interface. The device side software of the data card maps all of other function interface data of the data card into the HID function interface, and takes the HID function interface as a channel so as to interact data with a PC side. An operating system of the computer automatically obtains and runs green software built in a storage area of said data card.

### TECHNICAL FIELD

The present invention relates to the communication field, and particularly, to an implementation method, an operation method and a system of a data card driver free installation.

### BACKGROUND OF THE RELATED ART

At present, with the rapid development of the 3rd Generation (3G) mobile communication technology network, users not only have higher requirements for the traditional voice service of the mobile network, but also pay more and more attentions to wireless data services of the mobile network. The application of the 3G data card is wider and wider thereupon.

The existing method for using the data card is generally: firstly a user installing the driver program and user interface (UI) software of the data card on the computer, and then being able to use the user card. This method has following drawbacks:

firstly, the operation is troublesome and consumes much time and energy. The user completely installing all the drivers and UI software requires 3-5 minutes at least, and when the user uses the data card on another computer, the driver program and UI software are also required to reinstall, and the usage is rather troublesome;

secondly, the installation process needs that the user has a certain authority. Since the installation of the driver program needs that the user has the administrator authority, a common user is unable to install the driver program and UI software in an environment requiring the virtual private network (VPN) authentication such as an enterprise network, and is either unable to use the data card;

finally, since the different software environments of computers possibly cause that the data card is unable to be used. The software environment of each computer are quite different, and some system level software, such as an antivirus software and a monitoring software and so on, will stop the installation of the related driver and UI software, which causes the failure of the installation process of the data card software and affects the usage of the user.

### SUMMARY OF THE INVENTION

Regarding to above technical problems, the present invention proposes an implementation method, an operation method and a system of a data card driver free installation, which is able to conveniently operate the data card without installing the driver program and UI software, and avoids the problems of the troublesome process of installing the driver program and UI software of the data card, and the failure caused by user being required to have a certain authority and installation being easily affected by other software, and so on.

In order to solve the above technical problems, the present invention proposes an implementation method of a data card driver free installation, comprises:

device side software of a data card enumerating said data card as a compound device, and said compound device having at least one human interface device (HID) function interface of a HID type;

said device side software of the data card mapping all of other function interface data of said data card into said HID function interface, and taking said HID function interface as a channel interacting data with a PC side; and

developing green software and building said green software in a storage area of said data card; wherein said green software is graphical interface software free installation of a user layer, said green software is automatically obtained and run by an operating system of a computer after inserting said data card into the computer, to provide an operating platform for a user controlling said data card.

Further, the above implementation method can further have the following characteristic:

the device side software of said data card encapsulating the other function interface data as HID report format data, so as to implement mapping all of the other function interface data into said HID function interface.

Further, the above implementation method can further have the following characteristic:

the user controlling said data card to perform dial-up Internet connection through said green software, and directly invoke a browser on the computer to access the Internet.

Further, the above implementation method can further have the following characteristic:

the user further configuring a function of accessing the Internet through said green software.

In order to solve the above technical problems, the present invention further proposes a system of a data card driver free installation based on the above implementation method, comprising a PC layer and a device layer of the data card, wherein:

said PC layer obtains said green software from the storage area of said data card and automatically runs said green software after identifying that said data card is inserted; receives and identifies an user operation through said green software, and sends a control instruction of the user to the device layer of said data card through a HID user interface brought by a operating system self; and

said device layer of the data card receives the control instruction of the user through said HID function interface, analyzes said control instruction, and executes a data card operation according to the analyzed control instruction.

Further, the above system can further have the following characteristic:

said device layer of the data card is configured to execute a dial-up Internet connection operation after analyzing that said control instruction is a control instruction of dial-up Internet connection, obtain data from a network side, and send the obtained network data to the PC layer by the HID function interface;

said PC layer is configured to open a browser after identifying an operation of user invoking a PC browser, and provide a required webpage for the user according to the network data sent from said device layer of the data card.

Further, the above system can further have the following characteristic:

said PC layer comprises user interface (UI) software, a network core layer and a HID user interface, wherein:
said UI software is configured to obtain said green software from the storage area of said data card and automatically run said green software after said PC layer identifying that said data card is inserted; and said UI software is used for receiving and identifying the user operation, sending the control instruction of the user to said network core layer, opening the browser after identifying the operation of the user invoking the PC browser, and providing the required webpage for the user according to the network data sent from said device layer of the data card;
said network core layer is configured to encapsulate the control instruction sent from said UI software and then provide to the HID user interface; and encapsulate data sent from said HID user interface as a network protocol packet format, and provide upwards to said UI software;
said HID user interface is configured to send the control instruction of the user to said device layer of the data card, and send the network data sent from said device layer of the data card to said network core layer;

said device layer of the data card comprises a HID instruction analysis module, a DHCP server, a PPP protocol module responsible for a specific dial-up service and hardware for supporting software running, wherein:
said HID instruction analysis module is configured to analyze the control instruction of the PC layer sent through the HID user interface, and transmit the network data to said HID user interface of the PC layer after encapsulating the network data transmitted from the DHCP server as a HID packet format;
said DHCP server is configured to send the network data sent from said PPP protocol module to the HID instruction analysis module, and transmit the control instruction analyzed by said HID instruction analysis module down to said PPP protocol module;
said PPP protocol module is configured to perform dial-up Internet connection according to a control instruction of dial-up Internet connection of the user, and obtain the network data and then send to said DHCP server.

In order to solve the above technical problems, the present invention further proposes an operation method for controlling said data card by using the above system, comprising:

inserting said data card into a PC;

an operating system of the PC automatically running said green software built in said data card;

the user controlling said data card through said green software, a computer sending the control instruction of the user to said data card through said HID user interface, and the data card receiving said control instruction through said HID function interface, and performing data processing according to said control instruction.

Further, the above operation method can further have the following characteristic:

the user performs dial-up Internet connection through said green software;

the PC sends a control instruction of the dial-up Internet connection to said data card through said HID user interface;

said data card performs the dial-up Internet connection according to the control instruction of dial-up Internet connection, and obtains network data and then sends to said PC;

the user invokes a browser of the computer through said green software;

said PC opens the browser, and provides a webpage for the user according to the received network data.

Further, the above operation method can further have the following characteristic:

the user further configures a function of accessing the Internet through said green software.

The implementation method, operation method and system of a data card driver free installation proposed by the present invention are able to efficiently solve problems that user installing the data card driver program and UI software is troublesome and is limited by the authority, so that the user can freely use the data card in different computer environments, and the use process will not leave any trace in the target computer environment.

### BRIEF DESCRIPTION OF DRAWINGS

FIG. 1 is a flow chart of an implementation method of a data card driver free installation according to an embodiment of the present invention;

FIG. 2 is a block diagram of a system of a data card driver free installation according to an embodiment of the present invention;

FIG. 3 is a flow chart of a method for implementing operating the data card by using the system as shown in FIG. 2 according to an embodiment of the present invention.

### PREFERRED EMBODIMENTS OF THE PRESENT INVENTION

Below the present invention will be illustrated with reference to the accompanying drawings and specific embodiments in detail.

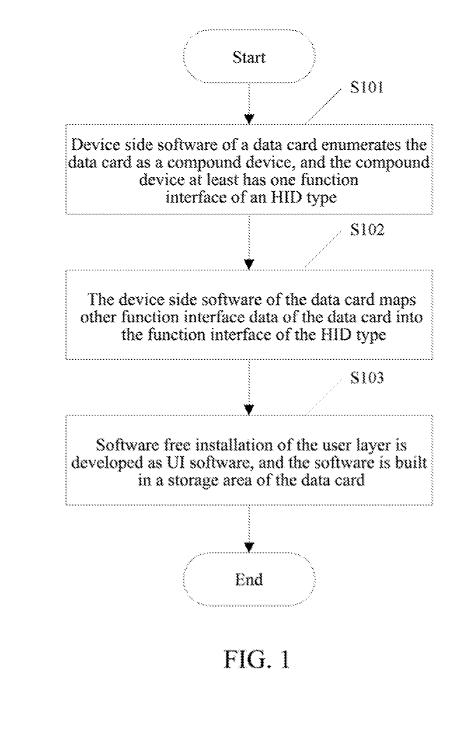

With reference to FIG. 1, FIG. 1 shows the implementation method of the data card driver free installation, and the implementation method comprises following steps:

step S101, the device side software (firmware) of a data card enumerates the data card as a compound device, and the compound device at least has one function interface of a human interface device (HID) type;

the compound device is generally a combination of device types such as an optical disk (CDROM) type device, a large capacity storage type device (MASS-STORAGE), and an HID type device, that is, the combination of the plurality of above types of devices will be displayed on the computer after inserting the data card into the computer;

step S102, the device side software of the data card maps the other function interface data of the data card, such as the modulator and demodulator (Modem) data and control (AT) data and so on, into the function interface of the HID type;

the device side software of the data card can encapsulate the modem data and the AT data and so on as a report format data of the HID type, thereby implementing mapping these data into the function interface of the HID type;

since the WINDOWS system provides a default driver program for the device of the HID type, the data card side can take the function interface of the HID type as a channel of interacting data with the PC side so as to establish the communication with the PC;

step S103, software free installation of the user layer is developed as graphical user interface (UI) software, and the software is built in a storage area of the data card.

Below the software is called as green software for convenient description. The green software provides an operating platform of user operating the data card, allows that the user can directly invoke a browser on the computer to access the Internet, and allows the user to perform various controls on the data card, such as configuring a PIN code, configuring network parameters, configuring a PUK code, and even accessing data and so on.

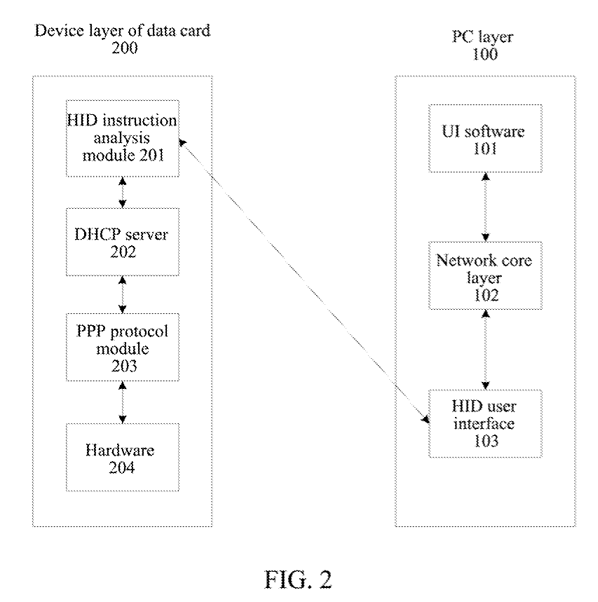

With reference to FIG. 2, FIG. 2 shows the system for implementing the data card driver free installation according to the embodiment of the present invention, and the system comprises a computer (PC) layer and a device layer of the data card.

The PC layer 100 is used for receiving and sending board side data in the PC operating system, and comprises: UI software 101, a network core layer 102 and a HID user interface (USER API) 103, wherein:

the UI software 101 is the green software in the data card mentioned above which is automatically obtained and run by the PC layer 100 after inserting the data card into the PC. The UI software 101 is used for using the application program, such as the IE, firefox, and chrome and so on, to load the Internet Protocol (IP) packets for the user surfing the Internet, after receiving the IP packets transmitted from the Network core 102; and receiving and identifying user operations, and sending control instructions of the user to the Network core 102. The control instructions can include: configuring the PIN code, configuring the network parameters, configuring the PUK code and even accessing data, and so on;

the Network core 102 is used for encapsulating the data transmitted from the HID USER API 103 as a standard IP packet format, and providing upwards to the UI software 101; at the same time, providing to the HID USER API 103 the control instructions of the user transmitted from the UI software 101 after encapsulating;

the HID USER API 103 is a direct link of the interacting between the PC layer 100 and the device layer (DEVICE) 200, which is responsible for sending the control instruction of the PC layer to the DEVICE layer, and receiving the data of the DEVICE layer to the PC layer at the same time.

The DEVICE layer 200 is used for receiving the network data transmitted from the wireless network and uploading the data to the PC layer, and analyzing the control instruction sent from the PC layer. The DEVICE layer 200 comprises an HID instruction analysis module 201, a DHCP server (SERVER) 202, a PPP protocol module 203 and a HardWare 204, wherein:

the HID instruction analysis module 201 is used for analyzing the control data of the PC layer transmitted from the HID USER API 103, and encapsulating the data transmitted from the DHCP server 202 into the format of the HID packet and then uploading to the HID USER API 103;

the DHCP server 202 is used for sending the network data transmitted from the PPP protocol module 203 to the HID instruction analysis module 201, and downloading the data analyzed by the HID instruction analysis module 201 to the PPP protocol module 203;

the PPP protocol module 203 is responsible for a particular dialing service and obtaining the network data;

the HardWare 204 is the physical hardware of the DEVICE200 layer, and supports the software running of the DEVICE200 layer.

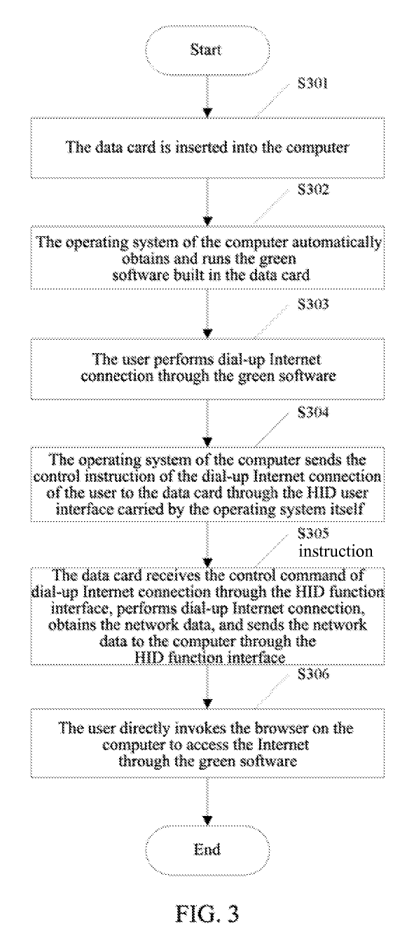

With reference to FIG. 3, FIG. 3 shows the method for operating the data card by using the system shown in FIG. 2, and the method comprises following steps:

step S301: the data card is inserted into the computer;

a green software is built in the data card, and the software is generally placed in the storage area of the data card, for example the optical disk or T card. The green software provides an operating platform for the user operating the data card, allows the user to directly invoke the browser on the computer to surf the Internet and to perform various controls on the data card, such as configuring the PIN code, configuring the network parameters, configuring the PUK code, and even accessing data, and so on.

Step S302, the operating system of the computer automatically obtains and runs the green software built in the data card;

step S303, the user performs dial-up Internet connection through the green software;

certainly, the user also can implement the control of the data card through the green software, for example configuring the function of accessing the Internet, such as configuring the PIN code, configuring the network parameters, and configuring the PUK code and so on. If such configurations have been configured, for example the PIN code has been configured, then the green software will prompt the user to input the PIN code when the user performs dial-up Internet connection, and if the verification is passed, the step S304 is carried out then, thereby being able to efficiently increase the security of the system.

Step S304, the operating system of the computer sends the control instruction of user dial-up Internet connection to the data card through the HID user interface brought by the operating system itself;

step S305, the data card receives the control instruction of the dial-up Internet connection through the HID function interface, performs the dial-up Internet connection, obtains the network data, and sends the network data to the computer through the HID function interface;

the HID instruction analysis module of the device side of the data card sends the control instructions to the AT function interface after receiving and analyzing the control instructions sent from the computer side, and sends the network data to the Modem function interface after receiving and analyzing the network data sent from the network side.

Step S306, the user directly invokes the browser on the computer to access the Internet through the green software.

Certainly, in another embodiment, if the green software also supports the user access operation, then the user also can sends the access control instruction through the green software, and sends the access control instruction to the data card side through the HID user interface of the PC side, thereby controlling the access operation of the data card.

The core concept of the present invention skillfully takes use of the default driver program provided by the operating system of the computer for the device of the HID type, takes the HID function interface brought by the operating system itself as the channel interacting with the data card side to interact data with the data card, and provides a convenient platform for the user operating the data card through the green software. Certainly, the present invention can also have other various embodiments, various corresponding modifications and variations can be made according to the present invention by those having ordinary skills in the art without departing from the spirit or essentiality of the present invention, and all the corresponding modifications and variations shall fall into the protection scope of the appended claims of the present invention.

### INDUSTRIAL APPLICABILITY

The implementation method, operation method and system of a data card driver free installation proposed by the present invention are able to efficiently solve problems that user installing the data card driver program and UI software is troublesome and is limited by the authority, so that the user can freely use the data card in different computer environments, and the use process will not leave any trace in the target computer environment.

What is claimed is:

1. An implementation method of a data card driver free installation, comprising:
device side software of a data card enumerating said data card as a compound device, and said compound device having at least one human interface device (HID) function interface of a HID type;
said device side software of the data card mapping all of other function interface data of said data card into said HID function interface, and taking said HID function interface as a channel interacting data with a PC side; and
providing green software and building said green software in a storage area of said data card; wherein said green software is graphical interface software free installation of a user layer, said green software is automatically obtained and run by an operating system of a computer after inserting said data card into the computer, to provide an operating platform for a user controlling said data card.

2. The implementation method as claimed in claim 1, wherein the step of mapping all of other function interface data of said data card into said HID function interface comprises:
the device side software of said data card encapsulating the other function interface data as HID report format data, so as to implement mapping all of the other function interface data into said HID function interface.

3. The implementation method as claimed in claim 1, wherein the user controlling said data card comprises:
the user controlling said data card to perform dial-up Internet connection through said green software, and directly invoke a browser on the computer to access the Internet.

4. The implementation method as claimed in claim 3, wherein the user controlling said data card further comprises:
the user further configuring a function of accessing the Internet through said green software.

5. A system of a data card driver free installation based on the implementation method as claimed in claim 1, comprising a PC layer and a device layer of the data card, wherein:
said PC layer obtains said green software from the storage area of said data card and automatically runs said green software after identifying that said data card is inserted; receives and identifies an user operation through said green software, and sends a control instruction of the user to the device layer of said data card through a HID user interface brought by a operating system self; and
said device layer of the data card receives the control instruction of the user through said HID function interface, analyzes said control instruction, and executes a data card operation according to the analyzed control instruction.

6. The system as claimed in claim 5, wherein:
said device layer of the data card is configured to execute a dial-up Internet connection operation after analyzing that said control instruction is a control instruction of dial-up Internet connection, obtain data from a network side, and send the obtained network data to the PC layer by the HID function interface;
said PC layer is configured to open a browser after identifying an operation of user invoking a PC browser, and provide a required webpage for the user according to the network data sent from said device layer of the data card.

7. The system as claimed in claim 6, wherein:
said PC layer comprises user interface (UI) software, a network core layer and a HID user interface, wherein:
said UI software is configured to obtain said green software from the storage area of said data card and automatically run said green software after said PC layer identifying that said data card is inserted; and said UI software is used for receiving and identifying the user operation, sending the control instruction of the user to said network core layer, opening the browser after identifying the operation of the user invoking the PC browser, and providing the required webpage for the user according to the network data sent from said device layer of the data card;
said network core layer is configured to encapsulate the control instruction sent from said UI software and then provide to the HID user interface; and encapsulate data sent from said HID user interface as a network protocol packet format, and provide upwards to said UI software;
said HID user interface is configured to send the control instruction of the user to said device layer of the data card, and send the network data sent from said device layer of the data card to said network core layer;
said device layer of the data card comprises a HID instruction analysis module, a DHCP server, a PPP protocol module responsible for a specific dial-up service and hardware for supporting software running, wherein:
said HID instruction analysis module is configured to analyze the control instruction of the PC layer sent through the HID user interface, and transmit the network data to said HID user interface of the PC layer after encapsulating the network data transmitted from the DHCP server as a HID packet format;
said DHCP server is configured to send the network data sent from said PPP protocol module to the HID instruction analysis module, and transmit the control instruction analyzed by said HID instruction analysis module down to said PPP protocol module;
said PPP protocol module is configured to perform dial-up Internet connection according to a control instruction of dial-up Internet connection of the user, and obtain the network data and then send to said DHCP server.

8. A method for controlling said data card by the system as claimed in claim 5, comprising:
inserting said data card into a PC;
an operating system of the PC automatically running said green software built in said data card;
the user controlling said data card through said green software, a computer sending the control instruction of the user to said data card through said HID user interface, and the data card receiving said control instruction through said HID function interface, and performing data processing according to said control instruction.

9. The method as claimed in claim 8, wherein:
the user performs dial-up Internet connection through said green software;
the PC sends a control instruction of the dial-up Internet connection to said data card through said HID user interface;
said data card performs the dial-up Internet connection according to the control instruction of dial-up Internet connection, and obtains network data and then sends to said PC;
the user invokes a browser of the computer through said green software;
said PC opens the browser, and provides a webpage for the user according to the received network data.

10. The method as claimed in claim 9, wherein:
the user further configures a function of accessing the Internet through said green software.
